(19) United States
(12) Patent Application Publication
(10) Pub. No.: US 2006/0286370 A1
(43) Pub. Date: Dec. 21, 2006

(54) Nano protective film structure

(76) Inventor: Tang-Chia Chiu, Banciao City (TW)

Correspondence Address: Connolly Bove Lodge & Hutz, LLP, P.O. Box 2207, Wilmington, DE, 19899-2207, US

(21) Appl. No.: 11/158,236

(22) Filed: Jun. 21, 2005

(51) Int. Cl. B32B 27/40; B32B 15/04; B32B 27/00

(52) U.S. Cl. 428/336; 428/457; 428/423.1; 428/702

(57) ABSTRACT

Disclosed is a nano protective film. At least one nanoscale or microscale organic film is formed on a substrate, and the organic film comprises a layer of PU resin or UV resin and a layer of nanoscale or micro scale coloring substance. Then, at least one nano inorganic film is formed on the organic film, and the nano inorganic film is a thin film comprising TiO₂, SiO₂, or Al₂O₃. At least one base layer 4 comprising a PU or UV resin and filler is formed between the organic film and the substrate. At least one transparent layer is formed on a surface of the organic film. By forming the inorganic film on the organic film, the protective film is capable of anti-corrosion, anti-oxidation, anti-fingerprint, and anti-static electricity, and has effects of filtering, luster, hardness increase, and surface flatness. The protective filter can be colored with any color to increase practicability. The protective film can be suitable to any martial, such as substrate can be metal, alloy, or plastic, to increase luster.

### BACKGROUND OF THE INVENTION

1. Field of the Invention

The present invention relates to a protective film structure, and more particularly to a nano protective film structure that is capable of anti-corrosion, anti-oxidation, anti-fingerprint, and anti-static electricity, and has effects of filtering, luster, hardness increase, and surface flatness.

2. Description of the Prior Art

In the conventional arts, a protective film structure mainly comprises an inorganic protective film structure and an organic protective film structure. The organic protective structure, such as paint, will be discolored and cracking under the radiation of ultraviolet light. Furthermore, the organic protective structure has capillaries, so that the waterproofing and weather fastness thereof are bad. Moreover, the organic protective structure is easy to generate static electricity and is CAPABLE OF SPARK that bring users high hazard. Although, a corrosion-resistant film can be formed by mixing a resin with a compound, such as Ti, Zr, Zn, Si, V, Al, etc, and then coated on a surface of a metal. The inorganic film in the conventional arts has some drawbacks. For example, a substrate of the inorganic film is limited to metal, and the cost of the inorganic film, the cost of the inorganic film is high, and the luster of the metal coated with the inorganic film is decreased.

In some conventional arts, a protective film is coated on a substrate by vacuum evaporation, such as CVD (Chemical Vapor Deposition) or PCD (Physical Vapor Deposition). The coating process must be executed in vacuum, and so the cost is high and the process is complicated. In addition, the protective film is often applied in conditions of high conductivity and high electromagnetic shield, and the color of the film is generally metallic color or the original color of the inorganic material. Therefore, the application thereof is restricted.

Hence, it is apparent that the conventional protective films are in need of improvement due to those many drawbacks.

### SUMMARY OF THE INVENTION

In those conventional arts, the protective films have the problems mentioned above. In view of this, the present invention is to coat at least one nanoscale or microscale organic film on a substrate, and then to coat at least one nano inorganic film on the organic film.

The main objective of the present invention is to provide a protective film that is capable of anti-corrosion, anti-oxidation, anti-fingerprint, and anti-static electricity, and has effects of filtering, luster, hardness increase, and surface flatness by forming the colorless inorganic film on the organic film comprising coloring substances. Furthermore, the protective filter can be colored with any color to increase practicability, and suitable to any martial, such as substrate can be metal, alloy, or nonmetal, such as plastic.

Another objective of the present invention is to increase surface luster of the substrate by forming a transparent light layer.

Still another objective of the present invention is to increase productive efficiency and to decrease cost by forming a base layer of filler between the organic film and the substrate to increase the surface flatness. Furthermore, the surface luster is further increased.

### BRIEF DESCRIPTION OF THE DRAWINGS

FIG. 1 is a schematic diagram of a nano protective film in the present invention;

FIG. 2 is a schematic diagram of a nano protective film with a base layer in the present invention;

FIG. 3 is a schematic diagram of a nano protective film with a light layer in the present invention; and

FIG. 4 is a schematic diagram of a nano protective film with a light layer of another embodiment in the present invention.

### DESCRIPTION OF THE PREFERRED EMBODIMENT

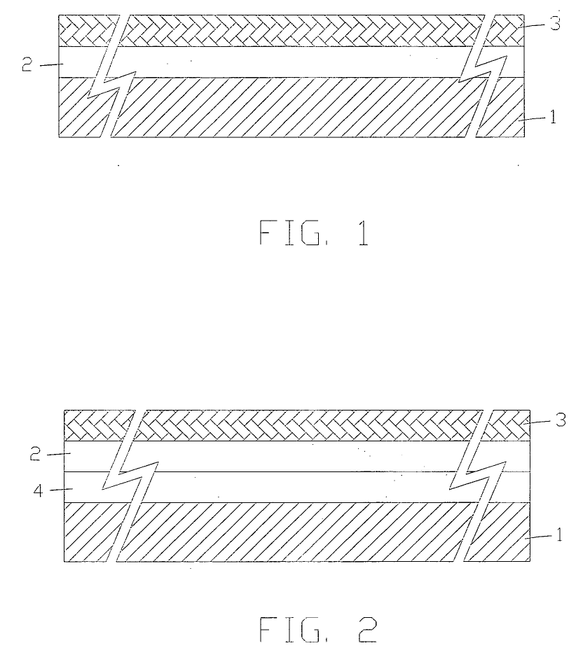

Referring to FIG. 1 and FIG. 2, they are structure diagrams of a nano protective film in the present invention. The nano protective film structure comprises a substrate 1, at least one organic film 2 on the substrate 1, and at least one nano inorganic film 3 on the organic film 2.

The substrate 1 can be plastic, metal, alloy, and so on. The organic film 2 is nanoscale or microscale film, and comprises a PU resin or UV resin, and a nanoscale or microscale coloring substance. If the surface of the substrate 1 is not even, at least one base layer 4 comprising a PU or UV resin and filler, as shown in FIG. 2, is formed between the organic film 2 and the substrate 1. The filler can be talcum powder, powder of calcium carbonate, and so on. The nano inorganic film 3 is a nanoscale thin film comprising TiO₂, SiO₂, or Al₂O₃.

By forming the nano protective film structure mentioned above, the protective film is capable of anti-corrosion, anti-oxidation, anti-fingerprint, and anti-static electricity, and has effects of filtering, luster, hardness increase, and surface flatness. The protective filter can be colored with any color to increase practicability.

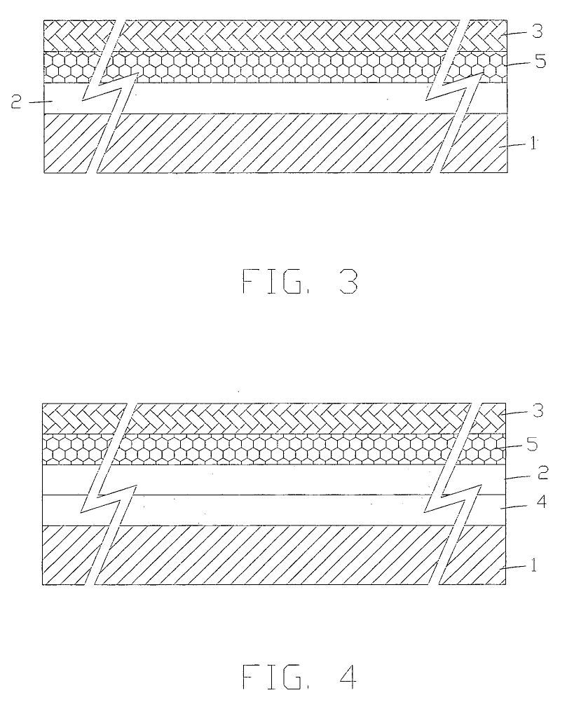

Referring to FIG. 3 and FIG. 4, they are structure diagrams of a nano protective film of another embodiment in the present invention. The nano protective film structure comprise a substrate 1, at least one organic film 2 on the substrate 1, at least one transparent light layer 5 on the organic film 2, and at least one nano inorganic film 3 on the transparent light layer 5.

The organic film 2 comprises a PU resin or UV resin, and a nanoscale or microscale coloring substance. If the surface of the substrate 1 is not even, at least one base layer 4 comprising a PU or UV resin and filler, as shown in FIG. 4, is formed between the organic film 2 and the substrate 1. The filler can be talcum powder, powder of calcium carbonate, and so on. The nano inorganic film 3 is a nanoscale thin film comprising TiO₂, SiO₂, or Al₂O₃.

By forming the nano protective film structure mentioned above, the protective film is capable of anti-corrosion, anti-oxidation, anti-fingerprint, and anti-static electricity, and has effects of filtering, luster, hardness increase, and surface flatness. Furthermore, the protective film can be suitable to any material, such as metal, alloy, or plastic, by forming the inorganic film on the organic film.

Although specific embodiments have been illustrated and described, it will be obvious to those skilled in the art that various modifications may be made without departing from what is intended to be limited solely by the appended claims.

What is claimed is:

1. A nano protective film structure, comprising:
a substrate;
at least one organic film formed on said substrate, said organic film being nanoscale or microscale; and
at least one nano inorganic film formed on said organic film;
whereby the nano protective film structure has good adsorbability and compact structure.

2. The nano protective film structure according to claim 1, wherein said substrate is plastic, metal, or alloy.

3. The nano protective film structure according to claim 1, wherein said organic film comprises a PU resin or a UV resin.

4. The nano protective film structure according to claim 1, wherein said organic film comprises a nanoscale coloring substance or a microscale coloring substance.

5. The nano protective film structure according to claim 1, wherein at least one base layer comprising a PU or UV resin and a filler is formed between said organic film and said substrate.

6. The nano protective film structure according to claim 5, wherein at least one transparent light layer formed on a surface of said organic film.

7. The nano protective film structure according to claim 1, wherein at least one transparent layer formed on a surface of said organic film.

8. The nano protective film structure according to claim 1, wherein said nano inorganic film is a thin film comprising TiO₂, SiO₂, or Al₂O₃.
